(19) United States
(12) Patent Application Publication
(10) Pub. No.: US 2011/0268852 A1
(43) Pub. Date: Nov. 3, 2011

(54) METHODS OF PROTEIN PROCESSING AND PRODUCT

(75) Inventors: Slivana Martini, North Logan, UT (US); Marie Walsh, North Logan, UT (US)

(73) Assignee: Utah State University, North Logan, UT (US)

(21) Appl. No.: 12/907,283

(22) Filed: Oct. 19, 2010

Related U.S. Application Data
(60) Provisional application No. 61/330,447, filed on May 3, 2010.

(51) Int. Cl. A23J 3/00; A23J 1/00

(52) U.S. Cl. 426/238; 426/656; 426/665

(57) ABSTRACT

This disclosure relates to the use of power ultrasound to provide for whey protein solutions with low turbidity. In one embodiment, power ultrasound is applied using a 20 kHz generator at between about 3 W and about 15 W. Power ultrasound may be applied for different application times, including, but not limited to about 5 minutes and about 15 minutes. Power ultrasound may be applied at temperatures between about 20° C. and about 60° C. In one embodiment, power ultrasound is applied with no temperature control [NTC]). In various embodiments the application of power ultrasound to whey suspensions is carried out on whey suspensions obtained at any of 4 identified, different steps in a common commercial process. In some embodiments and examples there is a 90% decrease in whey sample turbidity when power ultrasound is applied. A specific example is the 90% decrease in whey sample turbidity achieved when power ultrasound is applied to a whey suspension of 28.2% of solids containing 35.6% of protein on a dry basis. Favorable power ultrasound conditions include, but are not limited to, power ultrasound applied for 15 min using 15 W of mechanical power at 60° C. and NTC conditions. Surprisingly, increasing the protein content from 35.6% to 88.0% resulted in an increase in turbidity of samples with the same conditions.

### CROSS-REFERENCE TO RELATED APPLICATIONS

This application claims the benefit of U.S. Provisional Application No. 61/330,447, entitled “Method of Whey Protein Processing,” filed on May 3, 2010.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the field of protein processing. More specifically, the present invention is in the field of protein processing using ultrasound.

In the food industry, ultrasound has been used to monitor and induce lipid crystallization, to induce the crystallization of sugars and ice, to evaluate the rheology of food materials, and to reduce the size of carbohydrate molecules. Ultrasound techniques use sound waves of frequencies higher than those perceived by human hearing (>18 kHz). Acoustic waves can be applied to materials in the form of low intensity waves to passively monitor physical changes in the material caused by non-acoustic sources; or as high intensity waves (power ultrasound), where disruption of molecular entities or changes in the physicochemical characteristics of the materials are originated by the acoustic waves. In particular, power ultrasound has been commercially used in different food science applications such as emulsification, dispersion of solids, crystallization, de-gassing, and extraction.

Whey protein solubility is influenced by pH, temperature, and concentration. In general, whey proteins are the least soluble at pH 4.5-5.2 with an increase in solubility at acidic and alkaline pH values. In addition, there is usually a decrease in whey protein solubility with an increase in temperature.

Whey protein-containing beverages are generally formulated at acidic pH values because this results in a clear solution. A disadvantage to acidic beverages is that astringency is more pronounced necessitating the use of more sugar to offset the astringency. Beverages produced at neutral pH are generally opaque or turbid, even at just 2.5% protein, and less astringent, but require higher thermal processing temperatures than acidic beverages.

### BRIEF SUMMARY OF THE INVENTION

The present invention relates to methods of processing a food protein. In one embodiment, there is provided herein a description of applying power ultrasound to a food protein in a food protein suspension for a sufficient period of time and under sufficient conditions to transform a substantial portion of the food protein into a low turbidity food protein. Sufficient conditions may include, but are not limited to, a sufficient mechanical or acoustic power and a sufficient temperature, and wherein the food protein suspension is comprised of an appropriate solid content and protein content. An appropriate solid content and protein content may include any combination of solid content and protein content to which the applying of power ultrasound as described herein results in the production of a low turbidity food protein.

Without limiting the invention, the following examples related to the present invention are provided. In one example, the food protein suspension is less than 26 grams of protein per 100 grams of food protein suspension. In a second example the food protein suspension has a solid content of less than 30 grams of solids per 100 grams of food protein suspension. In a third example, the food protein suspension is less than 88 grams of protein per 100 grams of said solid content.

Optionally, the power ultrasound is applied with temperature control. Alternatively, power ultrasound is applied without temperature control.

The food protein may be selected from a group consisting of whey, casein, soy, albumen, and blended proteins. Also, the food protein may be any plant protein.

Without limiting the invention, in one example, the power ultrasound may be applied with an acoustic power between 0.31 and 4.48 Watts.

In a related embodiment, there is described herein the protein product produced by the methods described herein, which is a low turbidity protein. The applying power ultrasound results in the production of a low turbidity protein product. Accordingly, there is provided herein a method of processing a food protein resulting in a reduction of the turbidity of the food protein in a suspension or resuspension.

### BRIEF DESCRIPTION OF THE DRAWINGS

FIG. 1 shows a commercial whey processing scheme.

FIG. 2A shows the percent increase in transmission (Δ% T_{600 nm}) after sonication as a function of sonication time and mechanical power applied for a whey protein sample A from FIG. 1 when the sonication is performed with temperature control at 20° C. Bars in FIGS. 2A, 2B, and 2C with the same letter indicate that a significant difference between Δ% T_{600 nm} does not exist (α=0.05).

FIG. 2B shows the percent increase in transmission (Δ% T_{600 nm}) as a function of sonication time and mechanical power applied, following sonication (with temperature control) of a whey protein sample A from FIG. 1 at 60° Celsius, as compared to unsonicated sample A controls (Same letters on bars indicates that changes in % T_{600 nm} are not significantly different). Bars in FIGS. 2A, 2B, and 2C with the same letter indicate that a significant difference between Δ% T_{600 nm} does not exist (α=0.05).

FIG. 2C shows the percent increase in transmission (Δ% T_{600 nm}) as a function of sonication time and mechanical power applied, following sonication (without temperature control, “NTC”) of a whey protein sample A from FIG. 1 starting at 20° Celsius, as compared to unsonicated sample A controls (Same letters on bars indicates that changes in % T_{600 nm} are not significantly different). Bars in FIGS. 2A, 2B, and 2C with the same letter indicate that a significant difference between Δ% T_{600 nm} does not exist (α=0.05).

FIG. 3A shows the percent increase in transmission (Δ% T_{600 nm}) as a function of sonication time and power following sonication (with temperature control) of a sample B from FIG. 1 at 20° Celsius, as compared to unsonicated sample B controls (Same letter indicates that changes in % T_{600 nm} are not significantly different). Bars in FIGS. 3A, 3B, and 3C with the same letter indicate that a significant difference between Δ% T_{600 nm} does not exist (α=0.05).

FIG. 3B shows the percent increase in transmission (Δ% T_{600 nm}) as a function of sonication time and power following sonication (with temperature control) of a sample B from FIG. 1 at 60° Celsius, as compared to unsonicated sample B controls (Same letter indicates that changes in % T_{600 nm} are not significantly different). Bars in FIGS. 3A, 3B, and 3C with the same letter indicate that a significant difference between Δ% T_{600 nm} does not exist (α=0.05).

FIG. 3C shows the percent increase in transmission (Δ% T_{600 nm}) as a function of sonication time and power following sonication (without temperature control, “NTC”) of a sample B from FIG. 1 starting at 20° Celsius, as compared to unsonicated sample B controls (Same letter indicates that changes in % T_{600 nm} are not significantly different). Bars in FIGS. 3A, 3B, and 3C with the same letter indicate that a significant difference between Δ% T_{600 nm} does not exist (α=0.05).

FIG. 4A shows the percent increase in transmission (Δ% T_{600 nm}) as a function of sonication time and power following sonication (with temperature control) of a sample C from FIG. 1 at 20° Celsius, as compared to unsonicated sample C controls (Same letter indicates that changes in % T_{600 nm} are not significantly different). Bars in FIGS. 4A, 4B, and 4C with the same letter indicate that a significant difference between Δ% T_{600 nm} does not exist (α=0.05).

FIG. 4B shows the percent increase in transmission (Δ% T_{600 nm}) as a function of sonication time and power following sonication (with temperature control) of a sample C from FIG. 1 at 60° Celsius, as compared to unsonicated sample C controls (Same letter indicates that changes in % T_{600 nm} are not significantly different). Bars in FIGS. 4A, 4B, and 4C with the same letter indicate that a significant difference between Δ% T_{600 nm} does not exist (α=0.05).

FIG. 4C shows the percent increase in transmission (Δ% T_{600 nm}) as a function of sonication time and power following sonication (without temperature control, “NTC”) of a sample C from FIG. 1 starting at 20° Celsius, as compared to unsonicated sample C controls (Same letter indicates that changes in % T_{600 nm} are not significantly different). Bars in FIGS. 4A, 4B, and 4C with the same letter indicate that a significant difference between Δ% T_{600 nm} does not exist (α=0.05).

FIG. 5A shows the percent increase in transmission (Δ% T_{600 nm}) as a function of sonication time and power following sonication (with temperature control) of a sample D from FIG. 1 at 20° Celsius, as compared to unsonicated controls (Same letter indicates that changes in % T_{600 nm} are not significantly different). Bars in FIGS. 5A, 5B, and 5C with the same letter indicate that a significant difference between Δ% T_{600 nm} does not exist (α=0.05).

FIG. 5B shows the percent increase in transmission (Δ% T_{600 nm}) as a function of sonication time and power following sonication (with temperature control) of a sample D from FIG. 1 at 60° Celsius, as compared to unsonicated controls (Same letter indicates that changes in % T_{600 nm} are not significantly different). Bars in FIGS. 5A, 5B, and 5C with the same letter indicate that a significant difference between Δ% T_{600 nm} does not exist (α=0.05).

FIG. 5C shows the percent increase in transmission (Δ% T_{600 nm}) as a function of sonication time and power following sonication (without temperature control, “NTC”) of a sample D from FIG. 1 starting at 20° Celsius, as compared to unsonicated controls (Same letter indicates that changes in % T_{600 nm} are not significantly different). Bars in FIGS. 5A, 5B, and 5C with the same letter indicate that a significant difference between Δ% T_{600 nm} does not exist (α=0.05).

FIG. 6 shows the SDS-PAGE analysis of samples C and D. From left to right, lane 1 is molecular weight markers, lanes 2 and 3 are sample C: control, and sonicated for 15 min using 15 W of mechanical power at 60 C, respectively; and lanes 4 and 5 are sample D: control, and sonicated for 15 min using 15 W of mechanical power at 60 C, respectively.

### DETAILED DESCRIPTION OF THE INVENTION

Definitions
As used herein “food protein” means any ingestible protein that can be included in a protein suspension.
As used herein “food protein suspension” means a mixture in which particles, including but not limited to proteins, are dispersed throughout a liquid from which they are potentially filterable but not easily settled because of system viscosity or molecular interactions, and also specifically includes mixtures wherein some particles, including proteins, are in solution and some particles are in suspension.
As used herein “suspension” is meant to include mixtures in which microscopically visible particles are dispersed throughout a liquid from which they are easily filtered but not easily settled because of system viscosity or molecular interactions, and also specifically includes mixtures wherein some particles are in solution.
As used herein “low turbidity food protein” means a protein with its physiochemical properties altered such that upon suspension in a liquid, the turbidity of the suspension is less than what is observed for an unaltered protein of similar or identical composition.
As used herein “α-LB” means α-lactalbumin
As used herein “β-LG” means β-lactoglobulin
As used herein “BSA” means bovine serum albumin
As used herein “Cₚ” means specific heat capacity of the medium at constant pressure, expressed in J g⁻¹ K⁻¹

As used herein “A % T600 nm” means change in transmittance
As used herein “DSC” means Differential Scanning Calorimeter
As used herein “ΔH” means change in enthalpy, expressed in J/g
As used herein “dT/dt” means increase in temperature during sonication expressed in K/min
As used herein “NTC” means No temperature control
As used herein “m” means mass of substance, expressed in grams
As used herein “P” means acoustic power, expressed in Watts
As used herein “% T600 nm” means percentage of transmittance
As used herein “Tₒₙ” means Onset temperatures, expressed in ° C.
As used herein “Tₚ” means peak temperatures, expressed in ° C.
As used herein “Y” means heat flow, expressed in W/g
As used herein “beverage” means a liquid prepared for consumption and includes, but is not limited to, sports beverages, soft drink beverages, diet beverages, alcoholic beverages, non-alcoholic beverages, coffee based beverages, tea based beverages, herbal tea based beverages, water, flavored water beverages, and beverages used for health or body-building purposes.
As used herein, “power ultrasound” means ultrasound from 16-100 kHz.

The present invention relates to methods of using power ultrasound to provide a protein product useful in making protein containing beverages that are substantially clear in appearance. The methods may be practiced on a food protein by applying power ultrasound to a food protein in a food protein suspension for a sufficient period of time and under sufficient conditions to transform a substantial portion of the food protein into a low turbidity food protein. Sufficient conditions may include a sufficient mechanical or acoustic power and a sufficient temperature. The food protein suspension to which power ultrasound is applied may include an appropriate solid content and protein content. The food protein and resulting low turbidity food protein may be in a chemical or physical association with other solids.

In one embodiment there are herein examples related to the use of power ultrasound to decrease the turbidity of whey suspensions. Whey suspensions contain whey proteins and can be provided by various means, including, but not limited to, collecting a whey suspension from a whey production line, resuspension of processed whey proteins, or any other means known in the art.

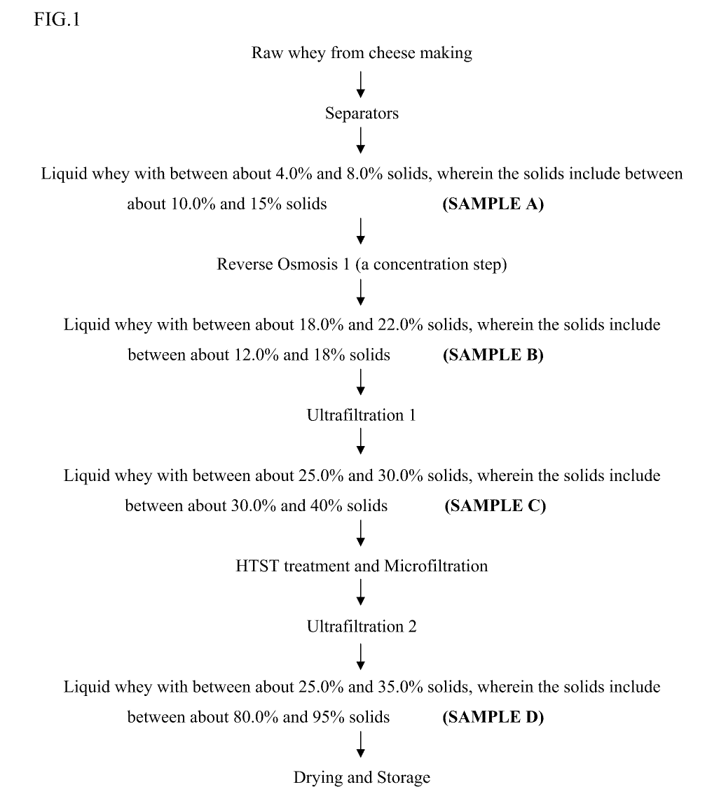

In one embodiment, this disclosure provides for whey proteins useful, for example, in manufacturing sports drink beverages containing protein, which have the appearance of a substantially clear beverage. In one embodiment, power ultrasound is applied to whey proteins using a 20 kHz generator at a mechanical power between about 3 W and about 15 W. Power ultrasound may be applied for different application times, including, but not limited to between about 5 minutes and about 15 minutes. Power ultrasound may be applied at temperatures between about 20° C. and about 60° C. In some embodiments, power ultrasound is applied with no temperature control (NTC). In various embodiments the application of power ultrasound to whey proteins is carried out on whey proteins obtained at any of 4 identified, different steps in a common commercial process, as shown in FIG. 1. Referring again to FIG. 1, there is shown a flow diagram representative of a liquid whey production line, which indicates the point during processing that the whey protein samples (A, B, C, D) were taken from. Sample A was comprised of liquid whey with 6.9% solids, of which 13.5% was protein. Sample B was comprised of liquid whey with 20.1% solids, of which 15.0% was protein. Sample C was comprised of liquid whey with 28.2% solids, of which 35.6% was protein. Sample D was comprised of liquid whey with 30.2% solids, of which 88.0% was protein.

In some embodiments and examples there is a 90% decrease in whey protein suspension turbidity when power ultrasound is applied, as compared to control whey protein suspension prepared without the application of power ultrasound. A specific example is the 90% decrease in whey protein suspension turbidity achieved when power ultrasound is applied to a whey protein suspension comprised of about 28.2% of solids, wherein the solids contain about 35.6% of protein on a dry basis. Power ultrasound conditions include, but are not limited to, power ultrasound applied for about 15 minutes using 15 W of mechanical power at 60° C. and NTC conditions. Using the same power ultrasound conditions but increasing the protein content of the solids from 35.6% to 88.0% resulted in an increase in turbidity for whey protein suspensions produced under similar power ultrasound conditions, thus demonstrating the unpredictability of the art of applying power ultrasound to whey proteins.

The following materials and methods have been used to practice some disclosed embodiments and examples and may be useful in practicing or giving guidance in the practice of all of the various embodiments and examples disclosed herein and related to the present invention:

### Materials and Methods

### Samples

Liquid whey samples from a commercial whey production line. Four liquid whey samples (A, B, C, and D) were collected from the whey stream as shown in FIG. 1. Samples differed in their solid (6.9, 20.1, 28.2 and 30.2%) and protein content (13.5, 15.0, 35.6, and 88.0% on dry basis). Samples were transported refrigerated to Utah State University and immediately frozen upon arrival. Solid and protein contents of the samples were determined as described below.

### Solid and Protein Content

For solid content determination, 1 ml of each sample (A, B, C, and D) was measured into a weighing pan, and heated in a 68° C. oven for 3 days. Weight measurements were taken at 48 and 72 hours to ensure that samples were dry, as evidenced by no change in weight between these two time points. Protein content was determined using a Thermo Scientific Modified Lowry Protein Assay Kit (Waltham, Mass.) with bovine serum albumin (BSA) as the standard. One percent solid matter suspensions were prepared using de-ionized water (pH 7.0). Samples were vortexed to ensure a homogenous suspension and were further diluted with water to the milligram/ml range. Diluted samples were used to determine protein content based on the BSA standard curve according the manufacturer's protocol.

### Ultrasound Treatment

Fifty milliliters of each sample were used for the power ultrasound treatment. Samples were placed in a double walled beaker connected to a water bath. A 3.2 mm titanium microtip was used for ultrasound application using a Misonix Sonicator 3000 (Misonix Inc., NY) with a maximum output power of 600 W. Three mechanical power treatments were used on each sample: no mechanical power (control), low mechanical power (3 W of mechanical power), and high mechanical power (15 W of mechanical power). Each power setting was applied for 5 and 15 minutes. Temperature in the sample was kept at 20° C. or 60° C. using an external water bath and a double-walled beaker. In an alternative example, a “no temperature control” (NTC) condition was tested in which the measurement started at 20° C. but no temperature control was used during the application of power ultrasound. For the 20° C. condition, the water bath was set at 20° C. and samples were placed inside the double walled beaker for 8 minutes before treatment start, which yielded a starting temperature of 20° C. For the 60° C. experimental condition the water bath was set at 60° C. and samples were placed inside double walled beaker for 8 minutes before treatment start, which yielded a starting temperature of 55° C. After sonication, samples were gently swirled to dissolve any film layer that might have formed. For the NTC condition, sonication started at sample temperatures of 20° C. After sonication, samples were poured into two 50 mL tubes and placed immediately into a −20° C. freezer at a slight angle. Samples were kept at least 24 h in the freezer prior to freeze drying (Dura-Top, FTS Systems, NJ, USA).

### Freeze Drying

After sonication and freezing, all samples were freeze dried (Dura-Top MP Bulk Tray Dryer) for 4 days in the 50 mL tubes to ensure all available water was removed. Samples in each treatment were pooled and ground using a pestle and mortar for a minimum of 5 minutes and stored at −20° C.

### Calculation of the Acoustic Power

The acoustic power in the samples was calculated using equation [1].

$$P = m \times {C}_{p} \times ( \frac{d T}{d t} ) \qquad [ eq 1 ]$$

Where, P is the acoustic power in Watts; m is the mass of sonicated sample expressed in grams; Cₚ is the specific heat capacity of the medium at constant pressure, expressed in J g⁻¹ K⁻¹; and (dT/dt) is the increase in temperature during power ultrasound expressed in K/min.

The specific heat capacity of the sample was calculated using a differential scanning calorimeter (DSC) using equation 2.

$${C}_{p} = \frac{{Y}_{s} \times {m}_{r} \times {C}_{pr}}{{Y}_{r} \times {m}_{s}} \qquad [ eq 2 ]$$

As used in equation two, Cₚ is the specific heat capacities at a constant pressure, Y is the heat flow measured by DSC and m is the mass of the substance. For each parameter, sub indices “r” and “s” indicate reference and sample, respectively. To determine the specific heat capacity, the DSC was calibrated at 5° C./min and sapphire was used as reference (known heat capacity value for a specific temperature). Specific heat capacities were measured at 20 and 55° C.

### Turbidity Measurements

After freeze drying and grinding, a 1% solid suspension of the treated samples was prepared using de-ionized water (pH=7.0). The suspensions were kept under agitation for 2 hours to maximize sample dissolution. The final pH was 6.9±0.3. The turbidity was then measured with a Shimadzu Biospec-1601 (Columbia, Md.) at 600 nm as percentage of transmittance (% T_{600 nm}). The % T was standardized as a function of solid content and the effect of power ultrasound on the turbidity of the samples was expressed as percentage of change in transmission from the control at each temperature (20° C., 60° C. or NTC).

### Differential Scanning Calorimetry

The effect of power ultrasound on the denaturation of whey proteins was evaluated using DSC. Approximately 20% protein suspensions of the freeze-dried material were prepared using phosphate buffer at pH 7 (0.01M [Na₂HPO₄-7H₂O]). Between 10-15 mg of this suspension was placed in a DSC pan and sealed hermitically. DSC was run from 20° C. to 100° C. at 5° C./min. A pan with buffer solution was used as reference. An endothermic peak was observed at approximately 80° C. as a consequence of protein denaturation. Onset temperatures (Tₒₙ), peak temperatures (Tₚ) and enthalpies (ΔH) were recorded for each sample of interest. Temperatures were expressed in ° C. and enthalpies were expressed in J/grams of protein.

### Protein Solubility and Electrophoresis

Protein suspensions with 2% protein for samples C and D treated at 60° C. for 15 min using 3 and 15 W of power were prepared using de-ionized water and left 24 hours at room temperature. The pH of the resulting suspensions was 6.9±0.3. After 24 h, aliquots of each sample were taken and the remaining samples were centrifuged at 12,000 rpm for 25 min. Seven hundred microliters of the supernatant were used to measure the amount of protein dissolved using the Thermo Scientific Modified Lowry Protein Assay Kit as described before. The protein content of the samples prior to centrifugation was also determined. In this case, suspensions were vortexed before the protein assay to ensure a homogeneous suspension. Protein content was expressed in μg/mL. Data is reported as percentage of protein soluble in duplicate.

Samples C and D with power ultrasound at 15 W for 15 min at 60 C and their unsonicated controls (15 micrograms each) were analyzed by SDS-PAGE under reducing conditions using 12% TEO-CI SDS gel (Expedeon Inc., San Diego, Calif.) according to the manufacturer's protocol. The gel was stained with Bio-Safe Coomassie (Bio-Rad Laboratories, Hercules, Calif.) and dried.

### Statistical Analysis

Power ultrasound treatments, % T_{600 nm}, and solubility determinations were performed in triplicate. Data is reported as mean values and standard deviations. Significant differences between treatments (acoustic application temperature, time, and power) were analyzed with a three-way ANOVA using SAS 9.1.3. All significant differences were given at level of significance of p=0.05.

The following discussion relates to embodiments and examples of the present invention practiced by the materials and methods described above:

### Acoustic Power Obtained

The acoustic power applied to the samples was measured as described in the materials and method section. The mechanical power, the type of sample and the temperature of the experiments significantly affected the acoustic power obtained. Table 1 shows that in general, the acoustic power decreased with higher temperatures with average values of 1.21±0.22 W for 3 W of mechanical power at 20° C. and 0.82±0.65 W for 3 W of mechanical power at 60° C. Similarly, the average acoustic power levels found for 15 W of mechanical power were 3.14±2.23 W for 20° C. and 2.95±0.44 W for 60° C.

TABLE 1
Acoustic power (W) applied to the samples as a function
of sample temperature (° C.) and mechanical power (W).

| | Sample A | | Sample B | |
|---|---|---|---|---|
| Mechanical | (6.9% solids, 13.5% protein) | | (20.1% solids, 15.0% protein) | |
| Power | 20° C. | 60° C. | 20° C. | 60° C. |
| 3 W | 1.08 ± 0.17 ^{a} | 0.31 ± 0.25 ^{a} | 1.11 ± 0.15 ^{a, c} | 0.68 ± 0.01 ^{a} |
| 15 W | 3.32 ± 0.31 ^{b} | 2.84 ± 1.13 ^{b} | 3.91 ± 0.31 ^{b, d} | 2.75 ± 0.99 ^{b} |
| | Sample C | | Sample D | |
| | (28.2% solids, 35.6% protein) | | (30.2% solids, 88.0% protein) | |
| | 20° C. | 60° C. | 20° C. | 60° C. |
| 3 W | 1.12 ± 0.20 ^{a, c} | 0.55 ± 0.37 ^{a} | 1.55 ± 0.21 ^{c} | 1.77 ± 0.69 ^{a, c} |
| 15 W | 4.48 ± 0.20 ^{b, d} | 2.63 ± 1.32 ^{b} | 6.97 ± 1.32 ^{d} | 3.61 ± 1.52 ^{b, d} |

Samples with the same letter are not significant different (α = 0.05)

As expected, the acoustic power was significantly higher for the higher mechanical power with average values of 1.02±0.49 W for 3 W of mechanical power and 3.81±1.40 W for 15 W of mechanical power. In addition, acoustic power of sample D at 20° C. was significantly higher than most of the other conditions (Table 1). This may be due to the higher protein content of this sample. The increase in temperature and Cₚ values for the NTC condition during acoustic power measurement were the same as the ones observed for the 20° C. condition (since both conditions start at 20° C.); therefore, acoustic power levels for NTC conditions are exactly the same as the ones reported for 20° C. in Table 1.

### Ultrasound Application

A slight increase in temperature was observed during sonication for all temperatures tested (20, 60° C. and NTC) (Table 2). On average, when low power was used (3 W), the increase in temperature for samples sonicated at 20 and 60° C. at 5 min was 2.4° C., and 3.0° C. for 15 min.

TABLE 2
Temperature increases (in ° C.) during power ultrasound of the liquid whey samples A,
B, C, and D with solid contents of 6.9, 20.1, 28.2 and 30.2% and protein contents of
13.5, 15.0, 35.6, and 88.0%, respectively.

| | 20° C. | | 60° C. | | NTC¹ | |
|---|---|---|---|---|---|---|
| Sample | 3 W | 15 W | 3 W | 15 W | 3 W | 15 W |
| A | | | | | | |
| 5 min | 1.7 ± 0.6 ^{a} | 4.3 ± 0.6 ^{b} | 1.0 ± 0.0 ^{a} | 3.7 ± 0.6 ^{b} | 2.0 ± 0.0 ^{a} | 8.3 ± 0.6 ^{e} |
| 15 min | 2.3 ± 0.6 ^{a, b} | 6.7 ± 0.6 ^{d} | 3.0 ± 1.0 ^{a, b} | 2.0 ± 0.0 ^{a} | 5.0 ± 0.0 ^{c} | 18.3 ± 0.6 ^{g} |
| B | | | | | | |
| 5 min | 1.7 ± 0.6 ^{a} | 4.7 ± 0.6 ^{c} | 2.0 ± 1.0 ^{a} | 4.7 ± 0.6 ^{c} | 2.0 ± 0.0 ^{a} | 8.0 ± 1.0 ^{e} |
| 15 min | 2.0 ± 0.0 ^{a} | 3.7 ± 0.6 ^{b, c} | 1.7 ± 0.6 ^{a} | 4.0 ± 0.0 ^{b, c} | 6.0 ± 0.0 ^{c} | 23.0 ± 1.0 ^{h} |
| C | | | | | | |
| 5 min | 1.6 ± 0.3 ^{a} | 5.8 ± 0.3 ^{c} | 3.6 ± 0.6 ^{b} | 6.0 ± 1.0 ^{c} | 2.7 ± 0.4 ^{a} | 9.0 ± 1.0 ^{e} |
| 15 min | 1.8 ± 0.8 ^{a} | 6.8 ± 0.9 ^{c, d} | 3.4 ± 0.1 ^{b} | 6.3 ± 1.0 ^{c, d} | 6.2 ± 0.4 ^{c} | 25.1 ± 0.2 ⁱ |
| D | | | | | | |
| 5 min | 3.3 ± 0.6 ^{b} | 9.0 ± 0.0 ^{e} | 5.0 ± 1.0 ^{c} | 6.3 ± 0.6 ^{d} | 3.0 ± 0.0 ^{a} | 16.3 ± 0.6 ^{h} |
| 15 min | 5.7 ± 0.6 ^{c} | 10.7 ± 0.6 ^{f} | 4.7 ± 0.6 ^{c} | 8.3 ± 0.6 ^{e} | 10.0 ± 1.0 ^{f} | 31.0 ± 1.0 ^{j} |

¹NTC stands for “no temperature control” condition.
Samples with the same letter are not significant different (α = 0.05)

As expected, in the case of the NTC samples, the increase in temperature during low mechanical power (3 W) was and 2.4° C. and 6.8° C. 5 and 15 min, respectively. The increase in temperature for temperature controlled samples (20 and 60° C.) at higher power (15 W) was 5.6° C. and 6.0° C. for 5 and 15 min, and 10.4° C. and 24.3° C. for NTC at 5 and 15 min. Da Table 2 suggests that power level had a greater influence on the increase in temperature than application time. The greatest increase in temperature during sonication was observed for sample D, which has the highest protein content. These increases in temperatures are in accordance with the power levels reported in Table 1.

### Turbidity Measurements

Sample turbidity was quantified as percent of transmitted light measured at 600 nm (% T_{600 nm}), wherein higher % T_{600 nm} indicates less turbid samples. FIGS. 1-4 show the % T_{600 nm} for samples A, B, C, and D, respectively as a function of power level (3 and 5 W) and duration (5 and 15 min). Data is expressed as the change in % T_{600 nm} (Δ% T_{600 nm}) compared to control samples (samples A, B, C, and D without power ultrasound). A positive value in this parameter indicates that the sample % T_{600 nm} is higher than the control, and therefore less turbid. Referring now to FIGS. 1A, 1B, and 1C, it can be seen that power ultrasound either increased or decreased transmission. Referring again to FIGS. 1A, 1B, and 1C, application temperature (20, 60° C., NTC) and time did not affect the change in % T_{600 nm} significantly for sample A (6.9% solids, said solids comprising 13.5% protein on dry basis), while power level (3 and 15 W) did affect the change in % T_{600 nm} significantly. The higher increase in transmission (approximately 15%) was observed when the sample was sonicated using 15 W of power. A decrease in transmission was observed for the sample A sonicated with 3 W for 5 min at 20° C. and with NTC. This data suggests that higher power levels and longer application times result in a moderate increase in the transmission of the sample and therefore in a less turbid material. Similarly, lower power levels applied for shorter periods will generate a more turbid material in sample A as shown by any of the negative values presented in FIGS. 1A, 1B, or 1C.

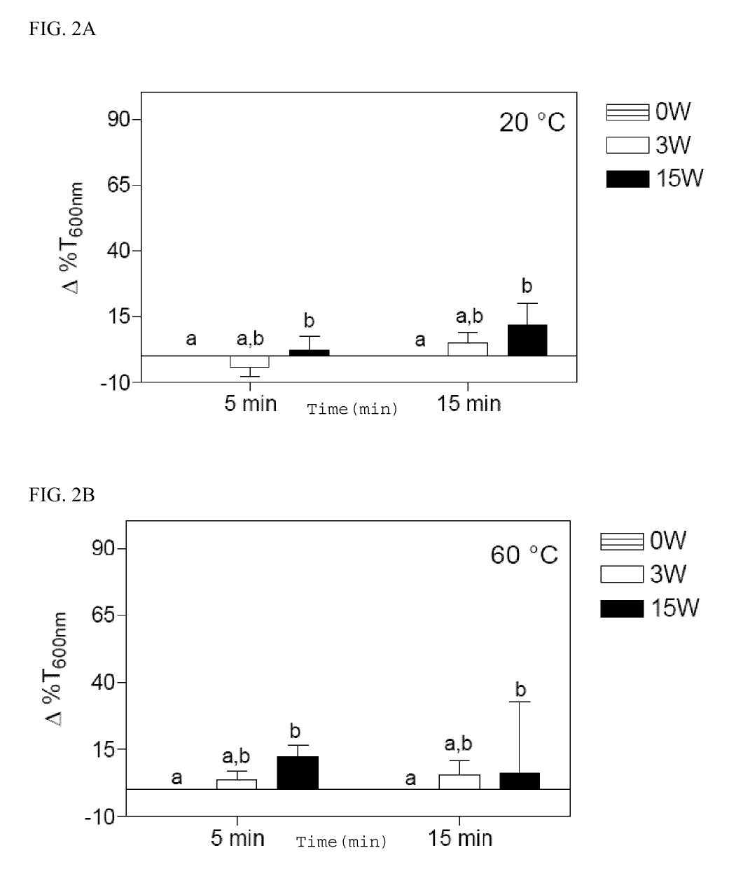

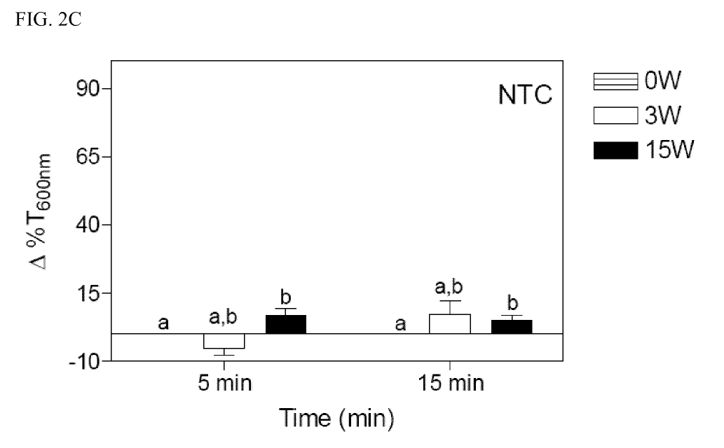

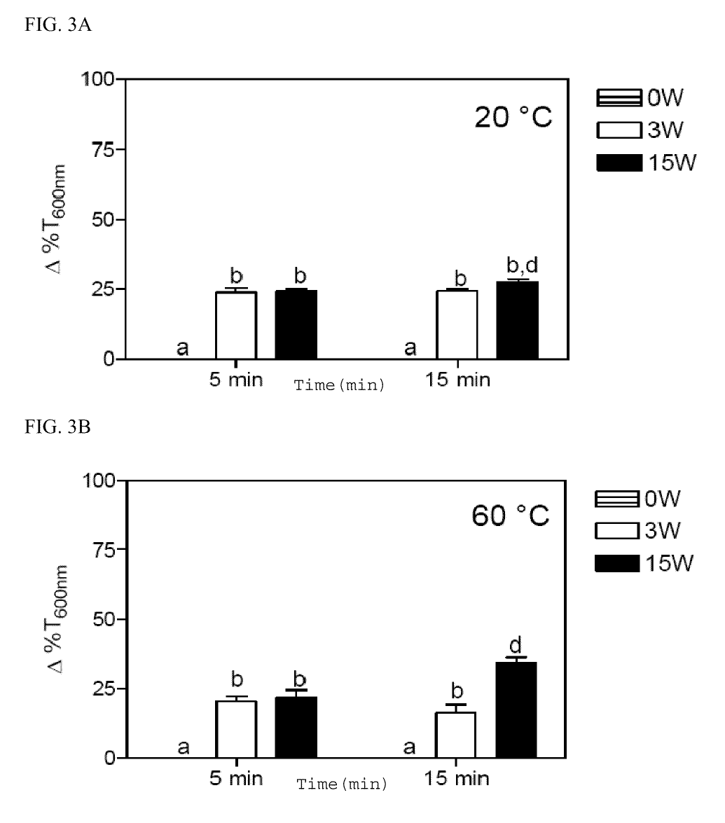

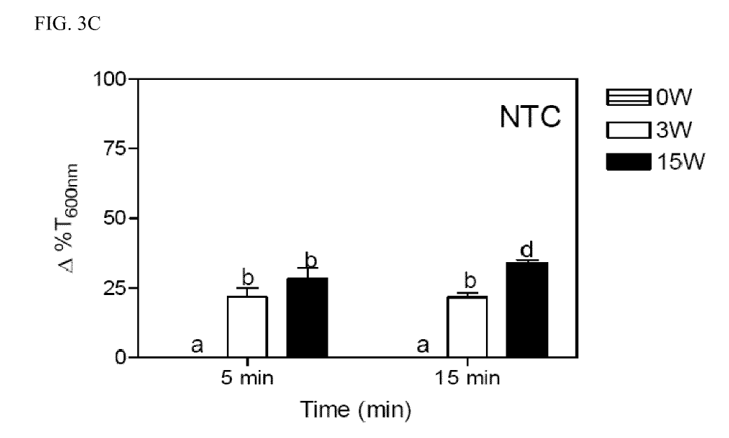

Referring now to FIGS. 2A, 2B, and 2C, data for sample B (20.1% solids, said solids comprising 15.0% protein on dry basis) show all power ultrasound conditions (temperature, time, and power level) significantly increased the transmission of the sample between 10-30%, indicating that less turbid samples were obtained with all treatments. Referring now to FIGS. 2A and 2C, transmission values were not significantly different in samples sonicated at 20° C. and NTC. Referring now to FIG. 3B, transmission values were significantly higher for samples sonicated at 60° C. Still referring to FIG. 3B, for example, transmission values were significantly higher for samples sonicated at 60° C., after 15 min of sonication with 15 W of mechanical power. Transmission was slightly increased for longer application times, and higher power levels. The main difference between samples A and B is believed to be the concentration step as shown in FIG. 1. Sample B has more solids content (20.1 vs. 6.9% for sample B and A, respectively) than sample A, while their protein content on dry basis, expressed as a percent of the solids in samples A and B, is approximately the same (15% vs. 13.5% for sample B and A, respectively). Results shown in FIGS. 1 and 2 suggest that the effect of power ultrasound on the turbidity of the sample may depend on its solid content. Higher solid content in the whey sample may resulting in a more efficient effect of power ultrasound on its turbidity is an unexpected discovery.

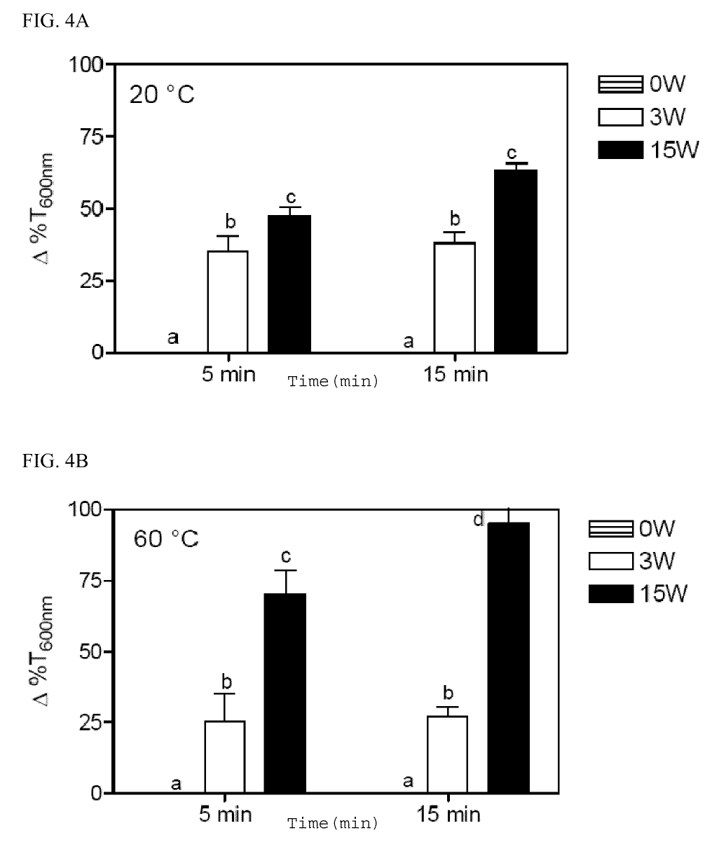

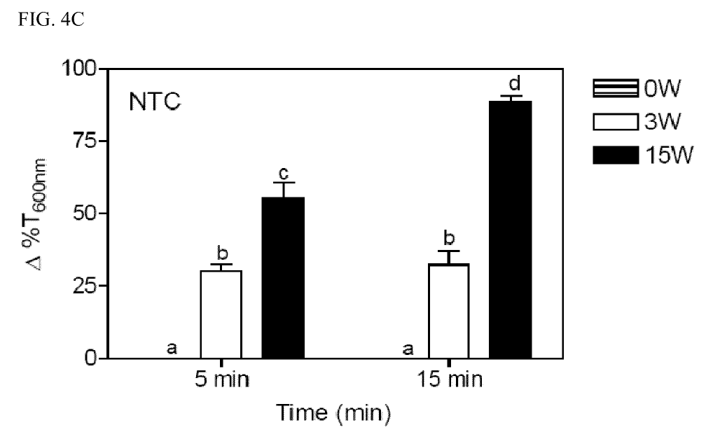

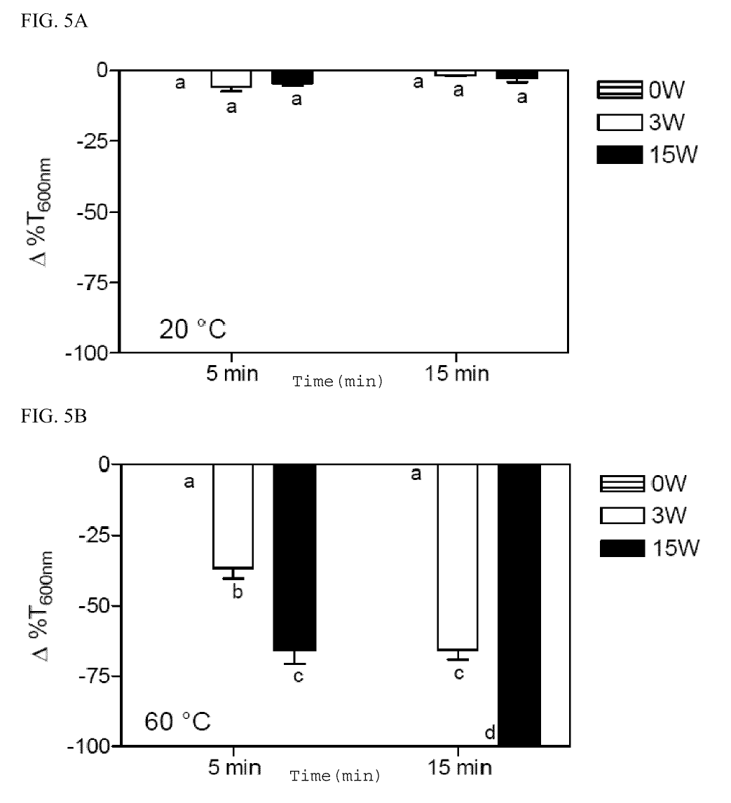

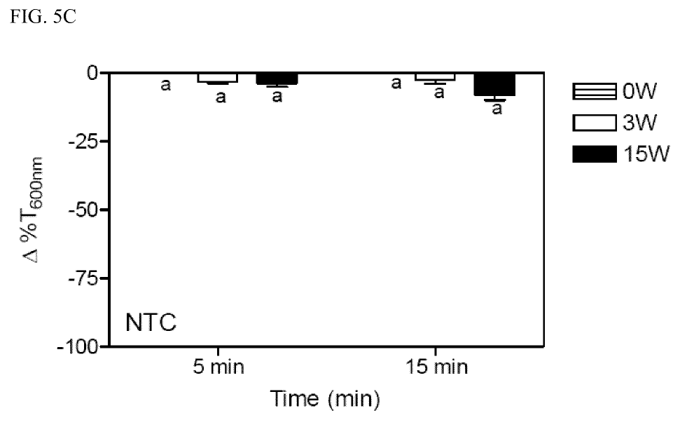

Referring now to FIGS. 3A, 3B, and 3C, there is shown the change in % T_{600 nm} for sample C (28.2% solids, said solids comprising 35.6% protein on dry basis). For all power ultrasound conditions, an increase in % T_{600 nm} was observed as a consequence of power ultrasound indicating that ultrasound decreased the turbidity of the whey samples. Referring now to FIG. 4A, application time did not affect the change in % T_{600 nm} significantly for the sample sonicated at 20° C., however, both application temperature and power level affected the change in % T_{600 nm} significantly. Referring now to FIGS. 3A and 3B, for samples sonicated for 15 min using 15 W of mechanical power the change in % T_{600 nm} of samples sonicated at 20° C. were significant lower from the ones sonicated at 60° C., and these values were not significantly different from the ones obtained for samples sonicated under the NTC condition shown in FIG. 4C. For FIGS. 3A, 3B, and 3C, values of change in % T_{600 nm} ranged from 25 to 100%. Referring now to FIGS. 3B and 3C, the largest change in % T_{600 nm} was observed for the samples sonicated at 60° C. (95.12±5.37%) and under the NTC condition (88.71±1.91%), using 15 W of power for 15 min. Unexpectedly, the observed change in % T_{600 nm} for sample C is higher than the ones observed for samples A and B. This suggests that in addition to solid content, protein content also plays an important role on the effectiveness of power ultrasound on improving the turbidity of whey solutions.

Referring now to FIGS. 4A, 4B, and 4C, there are shown changes in % T_{600 nm} for sample D (30.2% solids, said solids comprising 88.0% protein on dry basis). Unexpectly, and for all sample parameters tested, the transmission of these samples decreased as a function of power ultrasound conditions as compared to the unsonicated controls. Still referring to FIGS. 4A, 4B, and 4C, application temperature, time, and power level significantly affected the change in % T_{600 nm}. Referring now to FIGS. 4A and 4C, changes in % T_{600 nm} obtained from samples sonicated at 20° C. were not significantly different from the ones sonicated under NTC condition, however, now referring to FIG. 2B, changes in % T_{600 nm} for samples sonicated at 60° C. were significantly lower. Thus, applicants have unexpected discovered that for very high protein levels, as the ones observed in sample D, power ultrasound generates a more turbid suspension.

β-lactoglobulin (β-LG) is the most prevalent protein in whey. It comprises approximately 58% of the whey protein and exists as a dimmer at neutral pH. β-LG begins unfolding at 50° C. and is irreversibly denatured at 70° C. (pH 7.0) while α-lactalbumin (α-LB) begins to unfold at approximately 60° C. (pH 7) with complete denaturation at 80° C. α-LB has a higher thermal stability due to 4 disulfide bonds, no free thiol groups, and a calcium binding site while β-LG has 2 disulfide bonds and a free thiol group. At temperatures greater than room temperature, β-LG dissociates to monomers, exposing a free thiol group and hydrophobic residues. Each whey protein can aggregate via intramolecular interactions, with disulfide bonds possible with β-LG. Intermolecular aggregation is also observed at temperatures greater than 60° C., leading to large soluble aggregates (1.6×10⁶ g/mol). As mentioned before, the change in % T_{600 nm} for sample D at 60° C. might be due to the higher protein content of this sample and the tendency of temperature to induce aggregation. Sample D also showed a higher increase in temperature during sonication (Table 2) and acoustic power (Table 1) compared to the other samples.

It is possible that the protein-protein interactions that form at lower protein concentrations (sample C) are mainly hydrophobic and ionic and can be more easily disrupted than interactions (more disulfide in nature) that occur at higher protein concentrations (sample D) leading to a protein/temperature dependent change in turbidity.

### Solubility, Electrophoresis, and Thermal Denaturation of the Proteins

Considering the results described above, the best acoustic conditions to decrease the turbidity (higher change in % T_{600 nm}) in liquid whey samples obtained from a flow process are the ones obtained when ultrasound is applied for 15 min using 15 W of power at 60° C. and NTC conditions for a sample with 28.2% of solids and 35.6% protein on a dry basis (sample C). When the protein content was increased from 35.6% (sample C) to 88% (sample D) the efficiency of ultrasound decreased resulting in more turbid samples. To understand this effect, protein solubility, electrophoresis, and DSC were performed on samples C and D after being sonicated for 15 min using 15 W of power at 60° C.

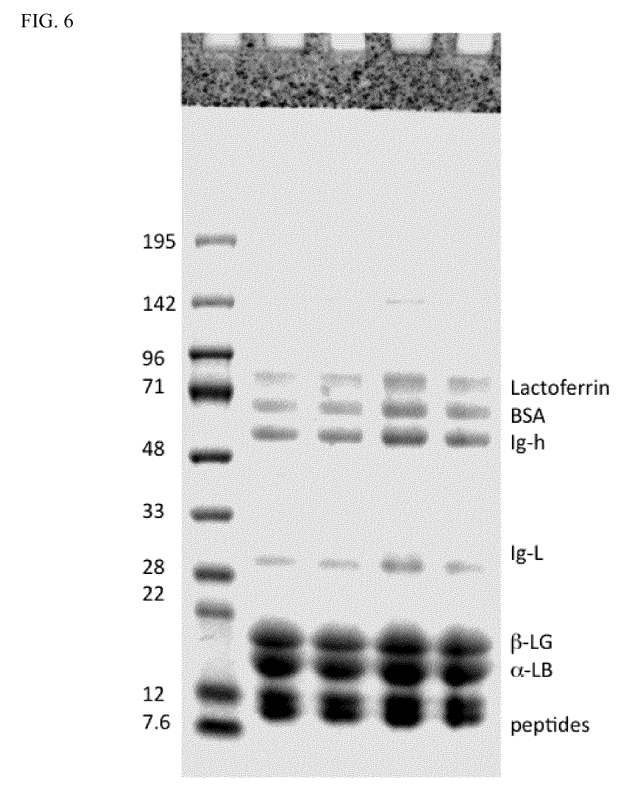

The possibility of whey proteins being degraded into peptides which increased clarity was investigated with protein solubility (Table 3) and SDS-PAGE electrophoresis (FIG. 6).

TABLE 3
Percent soluble protein in samples C, and D using 2%
protein with solid contents of 28.2 and 30.2% and protein
contents of 35.6, and 88.0, respectively.

| Samples | % Soluble Protein |
|---|---|
| C control | 98.3 ± 4.8 |
| C 60° C. 15 min | 98.7 ± 0.19 |
| C 60° C. 15 min 3 W | 99.3 ± 1.0 |
| C 60° C. 15 min 15 W | 98.4 ± 1.9 |
| D control | 101.0 ± 4.4 |
| D 60° C. 15 min | 98.8 ± 2.8 |
| D 60° C. 15 min 3 W | 98.3 ± 3.1 |
| D 60° C. 15 min 15 W | 91.1 ± 2.4 |

SDS-PAGE analysis demonstrated the protein-banding pattern is similar for all treatments, with no obvious degradation of any of the major whey proteins. The average solubility of each sample at a 2.0% protein concentration is similar as seen in Table 3. The only sample with a slightly lower solubility was sample D treated at 60° C. for 15 min at 15 W, and, referring once again to FIGS. 4A, 4B, and 4C, these were the same samples with a significant increase in turbidity.

The whey protein DSC denaturation parameters are given in Table 4. The onset denaturation temperature and the peak temperature of denaturation for all C samples are significantly higher than all D samples.

TABLE 4
DSC denaturation parameters.

| | Tₒₙ | Tₚ | ΔH |
|---|---|---|---|
| Samples | (° C.) | (° C.) | (J/g of protein) |
| C control | 82.1 ± 0.44 a | 85.3 ± 0.23 a | 3.64 ± 0.61 a |
| C 60° C. 15 min | 80.5 ± 1.48 a | 84.9 ± 0.17 a | 4.56 ± 0.15 a |
| C 60° C. 15 min 3 W | 81.8 ± 0.64 a | 84.8 ± 0.34 a | 2.16 ± 0.18 b |
| C 60° C. 15 min 15 W | 80.9 ± 0.80 a | 85.1 ± 0.19 a | 3.34 ± 0.13 a |
| D control | 69.8 ± 0.09 b | 75.0 ± 0.39 b | 8.59 ± 0.76 c |
| D 60° C. 15 min | 69.1 ± 2.29 b | 74.9 ± 0.13 b | 7.44 ± 0.88 c |
| D 60° C. 15 min 3 W | 71.8 ± 0.11 b | 75.4 ± 0.69 b | 3.81 ± 0.09 d |
| D 60° C. 15 min 15 W | 72.0 ± 0.52 b | 75.0 ± 0.03 b | 7.29 ± 0.03 c |

Tₒₙ: Onset temperature (° C.); Tₚ: Peak temperature (° C.), and ΔH: denaturation enthalpy (J/g). Liquid whey samples C, and D with solid contents of 28.2 and 30.2% and protein contents of 35.6, and 88.0, respectively.
For the same column, DSC values with the same letter are not significantly different (α = 0.05)

This data implies that the proteins in samples D are more readily denatured since denaturation occurs at lower temperatures. The enthalpy of denaturation of all D samples is significantly higher than the C samples implying the C samples denature at lower temperatures, but require more energy for denaturation. Considering that the D samples contain 88% protein, it is possible that the proteins are in an open-flexible structure that facilitates denaturation. This open protein structure may have resulted in protein-protein interactions (aggregation) that require more energy to disrupt. In addition, sample D underwent HTST thermal treatment followed by ultrafiltration. These steps may have lead to the slight unfolding of samples followed by protein-protein interactions during concentration. Within each sample, the samples sonicated at 3 W for 15 min resulted in the least enthalpy suggesting that the proteins in these samples were in an open-flexible structure. The fact that sample C has a lower denaturation enthalpy is also in agreement with the assumption made before related to the promotion of hydrophobic and ionic interactions using ultrasound which are more easily disrupted than disulfide interactions occurring at higher protein concentrations.

The mechanism that leads to an increase in clarity of specific whey protein samples at different treatments of power ultrasound is unclear. While the protein and solids concentrations, as well as the temperature, significantly influence the turbidity of the whey samples, the protein solubility, SDS-PAGE, and DSC analysis reveal that there is no degradation of proteins. A plausible mechanism may involve a change in the tertiary and quaternary structure of the whey proteins and/or minimization of any protein-protein interactions that would lead to aggregation and turbidity. Minimization of protein intermolecular associations is obviously concentration dependent since the use of power ultrasound resulted in more turbid samples with 88% protein compared to the samples with 36% protein.

### Embodiments and Examples

Reduced Turbidity in Whey protein Suspensions

In one embodiment there is disclosed the use of power ultrasound to decrease the turbidity of whey protein suspensions. In various example of the above-mentioned embodiment (Table 1), power ultrasound is applied using a 20 kHz generator at between about 3 W and about 15 W. Power ultrasound may be applied for different application times, including, but not limited to about 5 minutes and about 15 minutes. Power ultrasound may be applied at temperatures between about 20° C. and about 60° C. In a related embodiment, power ultrasound can be applied with no temperature control [NTC]). In other related embodiments the application of power ultrasound to whey suspensions is carried out on whey suspensions obtained at any of 4 identified, different steps in a common commercial process as shown in FIG. 1. In some embodiments and examples there is a 90% decrease in whey sample turbidity when power ultrasound is applied. One specific example of the above-mentioned embodiment is the 90% decrease in whey sample turbidity achieved when power ultrasound is applied to a whey suspension of 28.2% of solids containing 35.6% of protein on a dry basis. Favorable power ultrasound conditions include, but are not limited to, power ultrasound applied for 15 min using 15 W of mechanical power at 60° C. and NTC conditions.

For scale up, one may consider determining the appropriate ultrasound power in terms of acoustic power, rather than mechanical power.

### In-Line Processing

In one embodiment power ultrasound may be applied to a whey protein suspension during the normal commercial processing of whey proteins, as shown in FIG. 1.

### Turbidity Measurements

In one embodiment power ultrasound may be applied to a whey protein suspension to decrease the turbidity of said solution, and the turbidity may then be measured to confirm a desired decrease in turbidity. The decrease in turbidity may range from a 20% to a 99% decrease in turbidity.

As the present invention provides for reliable reduction in the turbidity of whey protein solutions, the various methods related to the present invention can, where desirable for conservation of time or money, or for other reasons, be practiced without precisely measuring the decrease in turbidity. Without limiting the invention in an undue way, no confirmation of decreased turbidity or, alternatively, a visual or other simple quality control method, quicker than the explicitly disclosed method for measuring decreased turbidity, can be employed.

### Beverage Production

The various embodiments and examples disclosed in this application may be useful in the production of a beverage that includes a desired amount of whey protein and that exhibits a desired level of turbidity, wherein the desired level of turbidity is less than the level present by the addition of whey protein to the beverage in the absence of power ultrasound.

The desired beverage may be, but is not limited to, a sports beverage, a soft drink beverage, a diet beverage, an alcoholic beverage, a non-alcoholic beverage, a coffee based beverage, a tea based beverage, or an herbal tea based beverage. Alternatively, the desired beverage may be water, or a flavored water beverage.

In one example, there is provided a method of producing a whey protein containing beverage, comprising: creating a whey protein suspension suitable for use in producing a beverage and applying power ultrasound to said whey protein suspension. The whey protein suspension suitable for use in producing a beverage may be provided in the form of an ingredient of the beverage, wherein power ultrasound can be used to decrease the turbidity of the whey protein suspension ingredient prior to addition to the beverage being produced, or, alternatively, wherein the power ultrasound is applied after the addition of the whey protein suspension to the beverage being produced, such that the beverage being produced is itself exposed to power ultrasound. For embodiments of the present invention related to the production of a beverage, said applying power ultrasound may reduce the turbidity of said whey protein suspension at least 20%, or at least 30%, or at least 40%, or at least 50%, or at least 60%, or at least 70%, or at least 80%, or at least 90%.

### Protein Sources

Proteins are linear polymers comprised of up to 20 different amino acids. Amino acids possess common structural features, including an α-carbon. Bonded to the α-carbon are an amino group, a carboxyl group, and a variable side chain.

In alternative embodiments, the power ultrasound methods for protein processing can be applied to one or more alternative protein sources to produce different protein products and protein suspensions useful in, but not limited to, providing protein suspensions or protein beverages, which are substantially clear in appearance.

In one alternative embodiment, power ultrasound may be used to provide for soy proteins, and soy protein suspensions, useful in the manufacturing or making of soy protein suspensions that are substantially clear in appearance, as well as soy proteins produced by the methods described herein. In one example, and without limiting either the above described embodiment or the broader invention, methods of processing soy protein may comprising applying power ultrasound to a soy protein suspension, wherein the power ultrasound is applied to the soy protein solution using a 20 kHz generator, and wherein the power ultrasound is applied with a mechanical power between about 3 watts and about 15 watts, and wherein the time of applying the power ultrasound is between about 5 minutes and about 15 minutes. A soy protein product useful in, but not necessarily limited to, manufacturing or making of soy protein suspensions that are substantially clear in appearance, may also be provide by the various methods describe herein.

In another alternative embodiment, power ultrasound may be used to provide for casein proteins, and casein protein suspensions, useful in the manufacturing or making of casein protein suspensions that are substantially clear in appearance, as well as casein proteins produced by the methods described herein. In one example, and without limiting either the above described embodiment or the broader invention, methods of processing casein protein may comprising applying power ultrasound to a casein protein suspension, wherein power ultrasound is applied to the casein protein solution using a 20 kHz generator, and wherein power ultrasound is applied with a mechanical power between about 3 watts and about 15 watts, and wherein the time of applying power ultrasound is between about 5 minutes and about 15 minutes. A casein protein product useful in, but not necessarily limited to, manufacturing or making of casein protein suspensions that are substantially clear in appearance, may also be provide by the various methods describe herein.

In yet another alternative embodiment, power ultrasound may be used to provide for albumen proteins, and albumen protein suspensions, useful in the manufacturing or making of albumen protein suspensions that are substantially clear in appearance, as well as albumen proteins produced by the methods described herein. In one example, and without limiting either the above described embodiment or the broader invention, methods of processing albumen protein may comprising applying power ultrasound to a albumen protein suspension, wherein power ultrasound is applied to the albumen protein solution using a 20 kHz generator, and wherein power ultrasound is applied with a mechanical power between about 3 watts and about 15 watts, and wherein the time of applying power ultrasound is between about 5 minutes and about 15 minutes. A albumen protein product useful in, but not necessarily limited to, manufacturing or making of albumen protein suspensions that are substantially clear in appearance, may also be provide by the various methods describe herein.

In still another alternative embodiment, power ultrasound may be used to provide for blended proteins, and blended protein suspensions, useful in the manufacturing or making of blended protein suspensions that are substantially clear in appearance, as well as blended proteins produced by the methods described herein. In one example, and without limiting either the above described embodiment or the broader invention, methods of processing blended protein may comprising applying power ultrasound to a blended protein suspension, wherein power ultrasound is applied to the blended protein solution using a 20 kHz generator, and wherein power ultrasound is applied with a mechanical power between about 3 watts and about 15 watts, and wherein the time of applying power ultrasound is between about 5 minutes and about 15 minutes. A blended protein product useful in, but not necessarily limited to, manufacturing or making of blended protein suspensions that are substantially clear in appearance, may also be provide by the various methods describe herein. Blended proteins may comprise any combination of whey, soy, casein, and albumen proteins, and may also include other proteins known to be nutritious.

In yet another embodiment, any of the protein sources described herein may be provided as a hydrolyzed protein. The scope of the invention includes, but is not limited to, all plant and animal proteins. When a protein, for example whey protein, is hydrolyzed the protein chains are broken down into peptides. Hydrolyzed proteins may still provide a high quality protein source, and they are less likely to cause allergic reactions than non-hydrolyzed proteins. Commonly, hydrolyzed protein is used in infant formulas and specialty protein supplements for medical use.

Table 5 lists proteins, protein sources, and uses, functions, or characteristics of the listed proteins. Nothing in table 5 is intended to limit the invention. The exemplar sources, and, uses, functions, and characteristics, are listed to assist those interested in practicing the invention disclosed herein in identifying various embodiments of the invention.

TABLE 5
Exemplar plant and animal protein sources and common uses.

| | | Noted Uses, Functions, or |
|---|---|---|
| Protein | Source | Characteristics |
| Whey | Commonly found in and | Beneficial to immune system |
| Protein | derived from milk in the | and used in nutritional |
| | cheese-making process | shakes |
| Casein | Commonly found in and | Use in beverages as weight |
| | derived from milk, and is | gainer or a meal replacer |
| | the primary protein in cheese | |
| Soy | Plant-based protein | Animal product free protein |
| | (made from soy beans) | |
| Albumen | Egg white powder | Weight loss, meal replacer, |
| | | or, vegetarian diets |
| Blended | Mixed protein sources | Commonly combine a quickly |
| | | absorbed protein source with |
| | | another that will be more |
| | | slowly digested over several |
| | | hours |

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of processing a food protein, comprising applying power ultrasound to a food protein in a food protein suspension for a sufficient period of time and under sufficient conditions to transform a substantial portion of the food protein into a low turbidity food protein.

2. The method of claim 1, wherein the sufficient conditions comprise a sufficient acoustic power and a sufficient temperature, and wherein the food protein suspension comprises an appropriate solid content and protein content.

3. The method of claim 1, wherein the sufficient conditions comprise a sufficient mechanical power and a sufficient temperature, and wherein the food protein suspension comprises an appropriate solid content and protein content.

4. The method of claim 1, wherein the food protein suspension comprises less than 26 grams of protein per 100 grams of food protein suspension.

5. The method of claim 1, wherein the food protein suspension comprises a solid content of less than 30 grams of solids per 100 grams of food protein suspension.

6. The method of claim 1, wherein solid content of the food protein suspension comprises less than 88 grams of protein per 100 grams of said solid content.

7. The method of claim 1, wherein power ultrasound is applied with temperature control.

8. The method of claim 1, wherein power ultrasound is applied without temperature control.

9. The method of claim 1, wherein the food protein is selected from a group consisting of whey, casein, soy, albumen, and blended proteins.

10. The method of claim 1, wherein the food protein is a plant protein.

11. The method of claim 1, wherein power ultrasound is applied with an acoustic power between 0.31 and 4.48 Watts.

12. The method of claim 1, wherein the applying power ultrasound results in the production of a low turbidity food protein.

13. The method of claim 1, wherein the food protein suspension comprises a whey protein suspension.

14. The method of claim 13, wherein the whey protein suspension comprises less than 26 grams of protein per 100 grams of food protein suspension.

15. The method of claim 13, wherein the whey protein suspension comprises less than 30 grams of solids per 100 grams of food protein suspension.

16. The method of claim 13, wherein the whey protein suspension comprises less than 88 grams of protein per 100 grams of said solid content.

17. A protein product produced by the method of claim 1.

18. A method of processing a food protein, comprising a step for reducing the turbidity of a protein containing suspension.
